(19) United States
(12) Patent Application Publication
(10) Pub. No.: US 2010/0238490 A1
(43) Pub. Date: Sep. 23, 2010

(54) INFORMATION PROCESSING APPARATUS, METHOD OF CONTROLLING INFORMATION PROCESSING APPARATUS, AND STORAGE MEDIUM

(75) Inventor: Junji Sato, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/708,354

(22) Filed: Feb. 18, 2010

(30) Foreign Application Priority Data
Mar. 18, 2009 (JP) 2009-066904

(51) Int. Cl. G06F 3/12

(52) U.S. Cl. 358/1.15; 358/1.16

(57) ABSTRACT

This invention provides an information processing system and control method thereof for reducing a storage capacity requested of a database and preventing the expiration of reference to image data. To accomplish this, in an information processing system according to this invention, when an image processing apparatus is to store the job history of an output job in a database via an information processing server, only attribute information including identification information of image data used to execute the job is stored. If the image data has already been stored in the database, the expiration date of the image data is changed to one added to the attribute information.

### BACKGROUND OF THE INVENTION

1. Field of the Invention

The present invention relates to an information processing apparatus and control method thereof in an information processing system which manages the job history of a job executed by an image processing apparatus such as a printer or digital multi-function peripheral.

2. Description of the Related Art

With the popularization of image processing apparatuses such as a printer and digital multi-function peripheral, anyone can easily print, copy, and send a document. This improves the user friendliness but causes information leakage that is a new problem when printing, copying, or sending a confidential document.

Known measures against this are an image processing apparatus which stores a job history in a storage apparatus when executing a job such as printing, copying, FAX transmission, or e-mail transmission, and an information processing system which manages a job history stored in such an image processing apparatus. The job history stored by the image processing apparatus includes information such as a user who executed a job, the date and time of execution, and job type, and information (IP address or serial number) for specifying the image processing apparatus. The job history sometimes includes image data of an image input when a job is executed, and reduced image data obtained by reducing the image data.

The information processing system is configured by an image processing apparatus and a server for managing a job history. The server includes a database for managing a job history. A job history stored by the image processing apparatus is transmitted to the database and stored in it. The database stores the job history in a searchable state and allows the system administrator to trace job execution information when, for example, information leakage occurs. To store many job histories in the information processing system, the image processing apparatus and database require a large-capacity storage apparatus.

To solve this, for example, Japanese Patent Laid-Open No. 2006-330939 proposes a method of reducing a storage capacity requested of a storage apparatus. According to this method, image data input/output to/from an image processing apparatus, and reference information of them are efficiently stored in the image processing apparatus or database. More specifically, when the user executes an input job as a job that inputs new image data to the image processing apparatus and executes processing, the image processing apparatus stores the image data as a job history in the storage apparatus. The user can reuse the stored image data and execute an output job that performs FAX transmission, e-mail transmission, or the like. In this case, not the reused image data but reference information serving as identification information of the image data is stored as a job history in the storage apparatus. The stored job histories of input and output jobs are transmitted to the database and managed. When an output job is detected in the database using the job history, image data stored by an input job can be referred to using the reference information. Since reference information stored by an output job has a small capacity, the storage capacity of the storage apparatus necessary for the image processing apparatus and database can be reduced.

However, according to the conventional technique, when image data at the reference destination of reference information stored as the job history of an output job is deleted, the contents of the image data cannot be confirmed when searching for the job history. The storage capacity of the database is generally limited in the information processing system. Thus, a job history stored for a predetermined period is deleted from the database after saved in a medium such as a magnetic tape suited to long-term storage. In this case, the job history of an input job stored in the database is deleted prior to that of an output job referring to the input job. As a consequence, when searching for the job history, the reference has expired and image data at the reference destination cannot be referred from reference information of the job history of the output job.

To solve this problem, it may be determined in advance whether image data at the reference destination of an output job exists in the database when transmitting a job history from the image processing apparatus to the database. If it is determined that image data at the reference destination of the output job does not exist in the database, the image processing apparatus transmits again the image data used, preventing the expiration of reference in the database. However, this method requires complicated processing in the image processing apparatus, so an existing image processing apparatus cannot cope with it. Further, image data need to be stored in preparation for retransmission and consume the limited storage capacity of the image processing apparatus.

### SUMMARY OF THE INVENTION

The present invention has been made to overcome the above-described drawbacks, and has as its object to provide an information processing apparatus and control method thereof for preventing the expiration of reference to image data associated with an executed job.

According to one aspect of the present invention, there is provided an information processing apparatus in an information processing system including an image processing apparatus which executes a job regarding image data, a storage apparatus which stores a history of the job executed by the image processing apparatus, and the information processing apparatus which receives the job history from the image processing apparatus and stores the job history in the storage apparatus, the information processing apparatus comprising: a first reception unit that receives history information of an input job which was executed by the image processing apparatus and input image data, image data of the input job, and identification information for identifying the image data; a second reception unit that receives history information of an output job which was executed by the image processing apparatus and output image data, and identification information for identifying image data of the output job; a storage unit that stores, in the storage apparatus, the history information, image data, and identification information of the input job received by the first reception unit, and the history information and identification information of the output job received by the second reception unit; an addition unit that adds, to at least the image data received by the first reception unit, expiration date information for storage indicating a period of storage in the storage apparatus; and a change unit that, when the second reception unit receives history information of an output job and identification information for identifying image data of the output job, changes an expiration date indicated by the expiration date information for storage added by the addition unit to image data specified by the same identification information as the received identification information.

According to another aspect of the present invention, there is provided a method of controlling an information processing apparatus in an information processing system including an image processing apparatus which executes a job regarding image data, a storage apparatus which stores a history of the job executed by the image processing apparatus, and the information processing apparatus which receives the job history from the image processing apparatus and stores the job history in the storage apparatus, the method comprising: receiving history information of an input job which was executed by the image processing apparatus and input image data, image data of the input job, and identification information for identifying the image data; receiving history information of an output job which was executed by the image processing apparatus and output image data, and identification information for identifying image data of the output job; storing, in the storage apparatus, the history information, image data, and identification information of the input job received in the step of receiving history information of an input job, and the history information and identification information of the output job received in the step of receiving history information of an output job; adding, to at least the image data received in the step of receiving history information of an input job, expiration date information for storage indicating a period of storage in the storage apparatus; and when history information of an output job and identification information for identifying image data of the output job are received in the step of receiving history information of an output job, changing an expiration date indicated by the expiration date information for storage added in the step of adding expiration date information, to image data specified by the same identification information as the received identification information.

The present invention can provide an information processing apparatus and control method thereof for preventing the expiration of reference to image data associated with an executed job.

Further features of the present invention will become apparent from the following description of exemplary embodiments (with reference to the attached drawings).

### BRIEF DESCRIPTION OF THE DRAWINGS

FIG. 1 is a block diagram exemplifying the schematic configuration of an information processing system according to an embodiment of the present invention;

FIG. 2 is a block diagram exemplifying the configuration of a digital multi-function peripheral according to the embodiment of the present invention;

FIG. 3 is a table exemplifying the classification of a job executed by the digital multi-function peripheral and the type of image data stored in a database according to the embodiment of the present invention;

FIG. 4 is a view exemplifying the contents of a job history stored in the database by the digital multi-function peripheral according to the embodiment of the present invention;

FIG. 5 is a view exemplifying attribute information stored in the database by the digital multi-function peripheral according to the embodiment of the present invention;

FIG. 6 is a table exemplifying a job history stored in the database in the information processing system according to the embodiment of the present invention;

FIG. 7 is a table exemplifying a job history stored in the database in the information processing system according to the embodiment of the present invention; and

FIG. 8 is a flowchart showing processing procedures when an information processing server in the information processing system stores a job history in the database according to the embodiment of the present invention.

### DESCRIPTION OF THE EMBODIMENTS

A preferred embodiment of the present invention will be described below. The embodiment to be described below would help understand various concepts such as superordinate, intermediate, and subordinate concepts of the invention. The technical scope of the present invention is defined by the scope of the claims, and is not limited by the following embodiment.

<Configuration of Information Processing System>

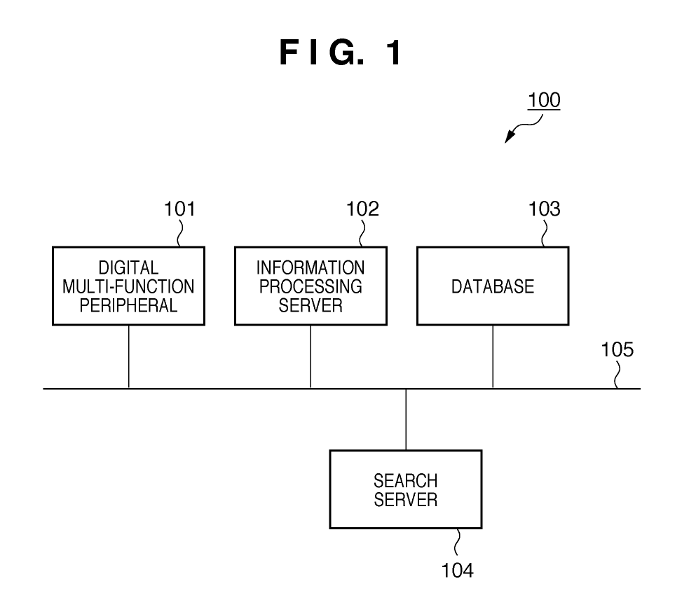

The embodiment of the present invention will be explained with reference to FIGS. 1 to 8. FIG. 1 is a block diagram exemplifying the schematic configuration of an information processing system according to the embodiment of the present invention. An information processing system 100 includes a digital multi-function peripheral 101, information processing server 102, database (storage apparatus) 103, and search server 104. These apparatuses are connected to each other via a network 105.

The digital multi-function peripheral 101 is an image processing apparatus having, for example, scan, print, copy, e-mail, and FAX functions. The digital multi-function peripheral 101 has an area called a user box for saving image data in an internal storage. The digital multi-function peripheral 101 has a function of transmitting image data saved in this area by FAX or e-mail. The digital multi-function peripheral 101 has a function of storing a job history serving as history information of a job executed by it in the internal storage, and transmitting the stored job history to the database 103. The job history includes digital image data of a job, and attribute information formed from a user who executed the job, the date and time of job execution, device information of the digital multi-function peripheral, and the like. When executing an input job which inputs image data to the user box and uses it, the digital multi-function peripheral 101 transmits attribute information and image data of the job to the information processing server 102. The digital multi-function peripheral 101 can also execute an output job that reuses image data in the user box that has been input by an input job, without newly inputting image data to the user box. In this case, the digital multi-function peripheral 101 transmits only attribute information to the information processing server 102 without transmitting image data used. The attribute information includes identification information (document ID) uniquely assigned to image data transmitted when an input job is executed.

The information processing server (information processing apparatus) 102 has a function of performing data conversion processing for a job history received from the digital multi-function peripheral 101 and storing the processed job history in the database 103. The data conversion processing means, for example, processing of performing OCR processing for image data of a job history and extracting text information, and processing of converting the image data. The text information obtained by the data conversion processing is stored in the database 103 in association with the job history and used to search for the job history. When transmitting a job history to the database 103, the information processing server 102 adds expiration date information for storage indicating a period during which the job history is saved. The information processing server 102 can be implemented by, for example, a general-purpose computer apparatus. The computer apparatus includes a CPU, ROM, RAM, and hard disk. The CPU loads a computer program from the ROM or hard disk to the RAM and executes processing of the embodiment.

The database 103 stores, as a job history, image data transmitted from the information processing server 102, associated text information, and attribute information. The database 103 suffices to be a storage apparatus for storing a job history, and may be, for example, a file server. A job history stored in the database 103 is deleted when it satisfies a predetermined condition. The predetermined condition is generally the expiration date of a job history, and the job history is deleted upon the expiration date. Note that the deletion processing is executed periodically at a predetermined timing, for example, once a day. The deletion processing may be done by issuing an SQL command from the information processing server 102 to the database 103, or searching for a job history to be deleted using the search server 104 to be described below. Also, the deletion processing may be scheduled as a batch job in the database 103 and executed periodically.

The search server 104 accepts a search condition such as a search keyword from the user, acquires a job history that meets the search condition from those stored in the database 103, and presents it to the user. Examples of the search condition are attribute information such as a user who executed a job, the date and time of job execution, and identification information of image data, and a character string in text information.

In the configuration of FIG. 1, the information processing system 100 includes the components 101 to 105 singly, but may include a plurality of components of each kind. A single server may incorporate different components. For example, a single server may incorporate the search server 104 and information processing server 102.

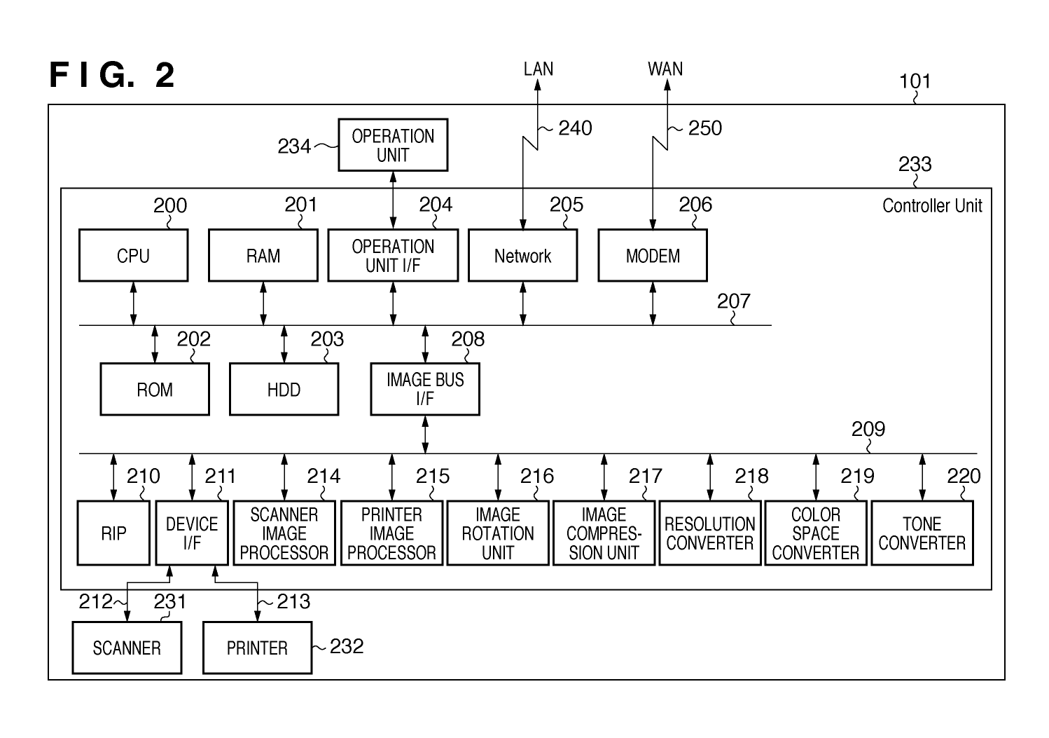

FIG. 2 is a block diagram exemplifying the configuration of the digital multi-function peripheral according to the embodiment of the present invention. A controller unit 233 is connected to a scanner 231 serving as an image input device and a printer 232 serving as an image output device. The controller unit 233 is connected to a network (LAN) 240 and public line (WAN) 250 to input/output image data and device information.

A CPU 200 is a controller that controls the overall system. A RAM 201 is a system work memory for operating the CPU 200 and also an image memory (buffer memory) for temporarily storing input image data. A ROM 202 is a boot ROM that stores the boot program of the system. A hard disk drive (HDD) 203 is a storage device that stores system software, job histories, image data in the user box, and the like.

An operation unit I/F 204 is an interface with an operation unit 234. The operation unit I/F 204 has a function of outputting, to the operation unit 234, window data to be displayed on it, and a function of outputting, to the CPU 200, information input by the user via the operation unit 234.

A network (Network) 205 is connected to the LAN 240 to input/output information. A modem (MODEM) 206 is connected to the WAN 250 to input/output image data.

The devices 200 to 206 are arranged on a system bus 207 and connected to an image bus 209 via an image bus (Image Bus) I/F 208. The image bus I/F 208 is a bus bridge that converts the data structure of image data when transmitting/receiving the image data between the system bus 207 and the image bus 209 at high speed. The following devices are arranged on the image bus 209.

A raster image processor (RIP) 210 rasterizes a PDL code into a bitmap image.

A device I/F 211 connects the controller unit 233, scanner 231, and printer 232 via an image input unit interface 212 and printing unit interface 213, and converts image data.

A scanner image processor 214 corrects, processes, and edits image data input from the scanner 231. The scanner image processor 214 has a function of determining, from the saturation signal of image data, which of color and monochrome documents is represented by the image data, and holding the determination result. A printer image processor 215 corrects, processes, and edits image data to be output to the printer 232.

An image rotation unit 216 rotates image data scanned by the scanner 231 in cooperation with the scanner image processor 214, and stores the rotated image data in a memory. The image rotation unit 216 can rotate image data in the memory and store the rotated image data in it. The image rotation unit 216 can also print out image data in the memory in cooperation with the printer image processor 215 while rotating it.

An image compression unit 217 performs JPEG compression/decompression for multilevel image data, and JBIG, MMR, MR, or MH compression/decompression for binary image data.

A resolution converter 218 converts the resolution of image data in the memory and stores the resultant image data in it.

A color space converter 219 converts, for example, YUV image data in the memory into Lab image data by matrix calculation and stores the Lab image data in the memory.

A tone converter 220 converts 8-bit image data of 256 tone levels in the memory into 1-bit image data of two tone levels by a method such as error diffusion processing, and stores the converted image data in the memory.

The devices 216 to 220 can operate in cooperation with each other. For example, the image rotation unit 216 and resolution converter 218 can cooperatively execute image rotation and resolution conversion for image data without the mediacy of the memory.

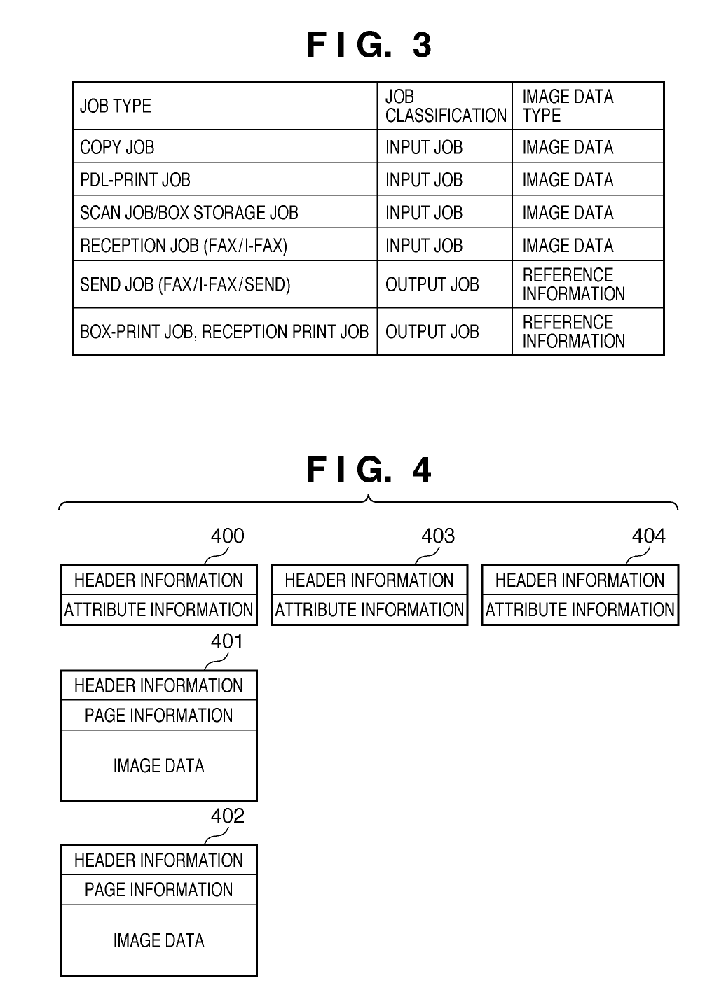

FIG. 3 is a table exemplifying the classification of a job executed by the digital multi-function peripheral 101 and the type of image data stored in the database 103 according to the embodiment of the present invention. An input job is to input image data to the user box and execute processing by the digital multi-function peripheral 101 using the image data. An output job is to reuse image data in the user box that has been input by an input job and execute processing by the digital multi-function peripheral 101.

As an example of an input job, a COPY job is to input the image of a document read by the digital multi-function peripheral 101 using the scanner 231. When executing an input job, the digital multi-function peripheral 101 stores attribute information and image data as a job history in the database 103. The attribute information includes a document ID (identification information) for uniquely identifying image data used to execute the job, which will be described later.

As an example of an output job, a BOX-PRINT job is to print by the digital multi-function peripheral 101 using, based on reference information, image data that has been stored in advance in the user box area of the HDD 203 by a BOX storage job. When executing an output job, the digital multi-function peripheral 101 stores only attribute information as a job history in the database 103 without storing image data used. As will be described later, the attribute information includes the document ID of image data used as reference information.

FIG. 4 is a view exemplifying the contents of a job history stored in the database 103 by the digital multi-function peripheral 101 according to the embodiment of the present invention. In FIG. 4, reference numerals 400 to 402 denote job histories of input jobs; and 403 and 404, job histories of output jobs. In this case, when attribute information and image data of respective pages are successively stored as the job histories 400 to 402 of the input jobs, pieces of attribute information are stored as the job histories 403 and 404 of the output jobs.

Header information formed from the format version, data size, and the like is added to each job history shown in FIG. 4. Image data of the job history is data representing the contents of the job. In most cases, the image data is an image format, but may be text data or binary data of a non-image format.

Page information of the job history contains the image data format, and when image data is an image format, further contains the image size, resolution, and the like.

Attribute information of the job history contains the document ID of image data used. For the job history of an input job, both attribute information containing a document ID and image data having the same document ID are stored together in the database 103. For the job history of an output job, only attribute information containing the document ID of image data used is stored without storing the image data. The job history of either job includes information (e.g., IP address or serial number) capable of specifying an image processing apparatus that executed the job. In the job history of an input job and that of an output job using image data input by the input job, pieces of attribute information of them have the same document ID.

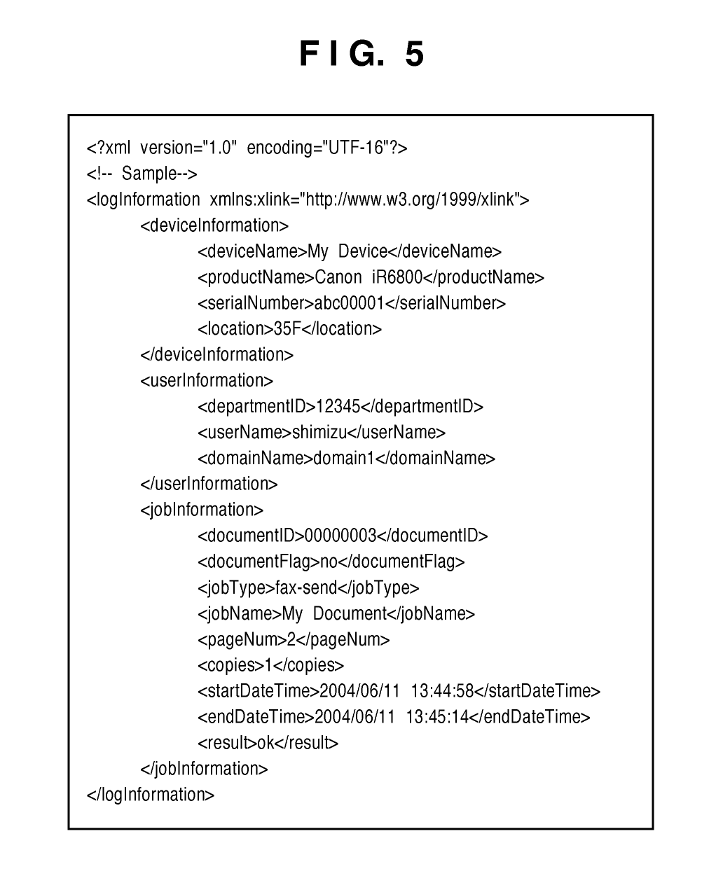

FIG. 5 is a view exemplifying attribute information stored in the database 103 by the digital multi-function peripheral 101 according to the embodiment of the present invention. In FIG. 5, the attribute information is stored in the XML format. In FIG. 5, a logInformation element representing attribute information contains a deviceInformation element, userInformation element, and jobInformation element.

The deviceInformation element includes device information such as the device name and serial number.

The userInformation element includes user information such as the department ID and user name.

The jobInformation element includes job type information indicating the job type, and job information such as the job name and the start date and time. A documentID element in the jobInformation element is a document ID which is a unique value indicating image data input by an input job. A documentFlag element is an image data flag, and holds “yes” when there is image data and “no” when there is no image data. In attribute information of an output job, the image data flag holds “no”, and the document ID is that of image data used to execute an input job.

<Operation of Information Processing System>

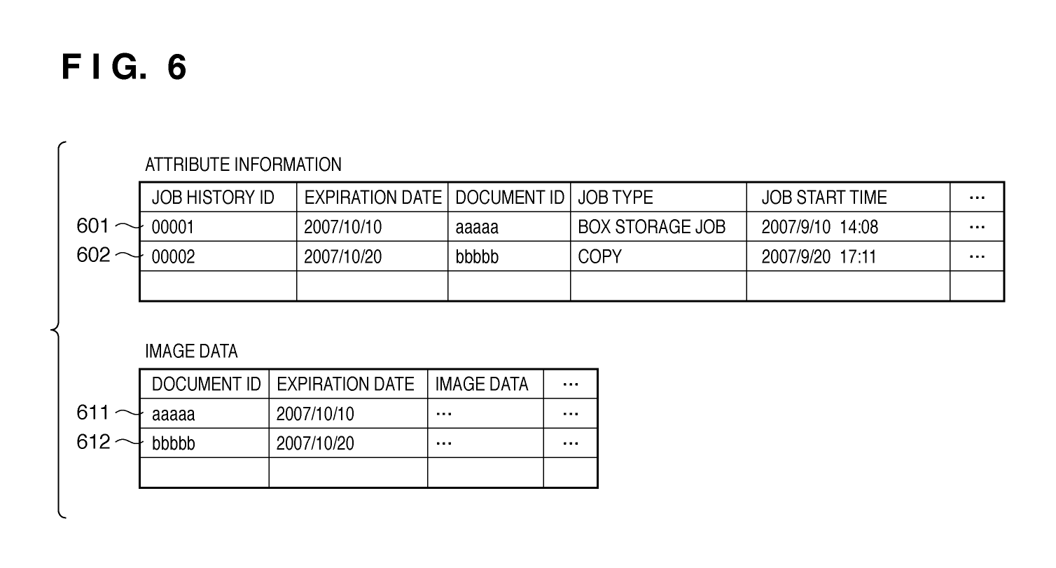

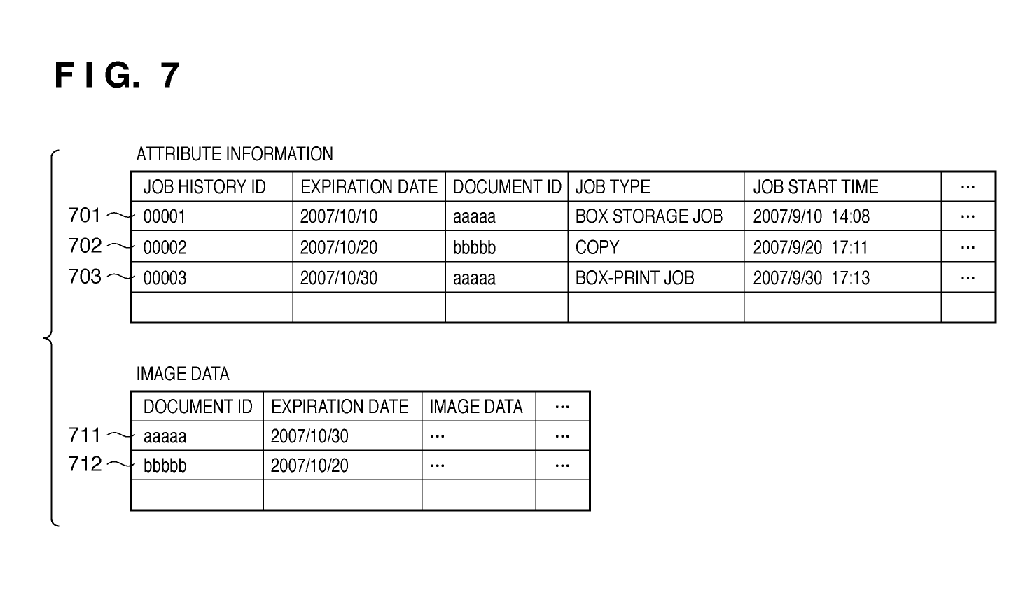

The operation of the information processing system 100 according to the embodiment of the present invention will be explained with reference to FIGS. 6 to 8. FIGS. 6 and 7 are tables exemplifying job histories stored in the database 103 in the information processing system 100 according to the embodiment of the present invention. In storage, a predetermined expiration date is set for attribute information and image data of a job history stored in the database 103. In the example of FIGS. 6 and 7, a period of 30 days from the date of storage is set for a predetermined expiration date. A job history after the expiration date is deleted from the database 103.

In the case of FIG. 6, the database 103 stores two job histories having pieces of attribute information assigned with a job history ID “00001” and job history ID “00002”.

A job history having attribute information 601 assigned with the job history ID “00001” is the job history of a BOX storage job which is one of input jobs and stores image data in the user box by the digital multi-function peripheral 101. This job was executed on 2007/9/10, and the job history is stored in the database 103. The document ID of the attribute information 601 of the job history is “aaaaa”, and corresponding image data 611 having the document ID “aaaaa” is also stored as a job history in the database 103. The expiration dates of both the attribute information 601 and image data 611 are set to 2007/10/10.

A job history having attribute information 602 assigned with the job history ID “00002” is the job history of a COPY job which is one of input jobs. This job was executed on 2007/9/20, and the job history is stored in the database 103. The document ID of the attribute information 602 of the job history is “bbbbb”, and corresponding image data 612 having the document ID “bbbbb” is also stored as a job history in the database 103. The expiration dates of both the attribute information 602 and image data 612 are set to 2007/10/20.

In the case of FIG. 7, a job history including attribute information assigned with a job history ID “00003” is newly stored in the database 103 in the state of FIG. 6. Note that data 701, 702, 711, and 712 in FIG. 7 are identical to the data 601, 602, 611, and 612 in FIG. 6.

A job history having attribute information 703 assigned with the job history ID “00003” is the job history of a BOX-PRINT job which is one of output jobs. This job was executed on 2007/9/30, and the job history is newly stored in the database 103. The document ID of the attribute information 703 of the job history is “aaaaa”, and the attribute information 703 refers to the same document ID as that of the attribute information 701 of the job history that has already been stored by the input job. This means that the BOX storage job corresponding to the attribute information 701 and the BOX-PRINT job corresponding to the attribute information 703 were executed based on the same image data.

From a comparison between FIGS. 6 and 7, the expiration date of the image data 611 having the document ID “aaaaa” is set to 2007/10/10 in FIG. 6, whereas that of the same image data 711 is changed to 2007/10/30 in FIG. 7. This is because the output job having the job history ID “00003” used the image data having the document ID “aaaaa” on 2007/9/30. When the job history of the output job having the job history ID “00003” is stored in the database with the expiration date of 2007/10/30, the expiration date of the image data 711 having the document ID “aaaaa” that was used by this job is also changed to the same date. Thus, even if the attribute information 701 is deleted from the database 103 on the expiration date of 2007/10/10, the corresponding image data 711 is not deleted. In other words, reference to the image data 711 at the reference destination in the job history of the attribute information 703 does not expire even after 2007/10/10.

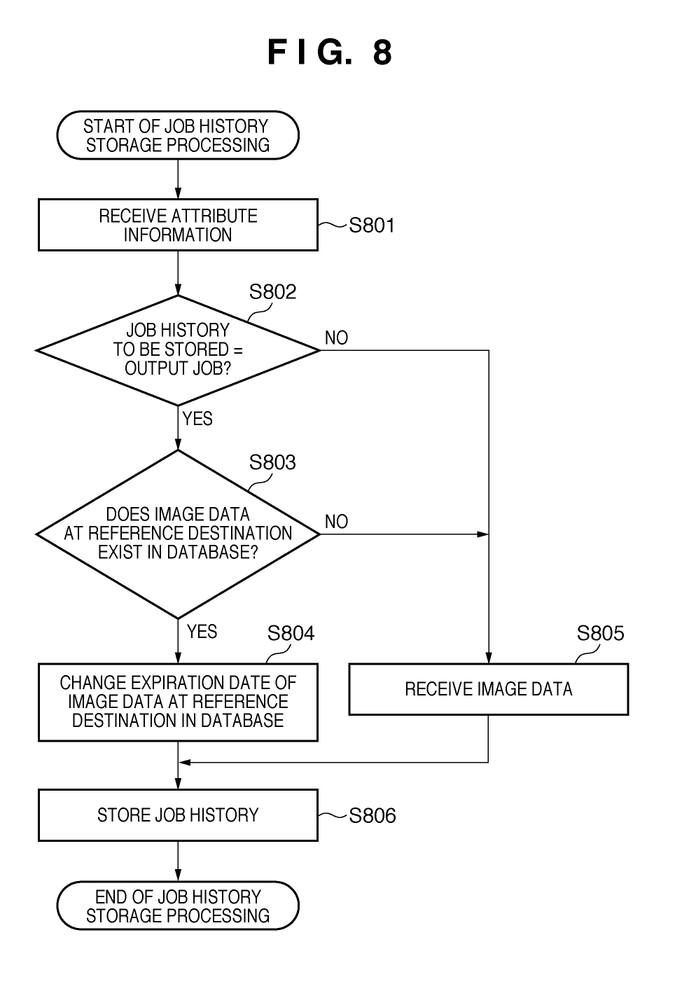

FIG. 8 is a flowchart showing processing procedures when the information processing server 102 in the information processing system 100 stores a job history in the database 103 according to the embodiment of the present invention. This flowchart shows the sequence of processing when the CPU of the information processing server 102 loads a computer program from the ROM or hard disk to the RAM and executes processing of the embodiment.

When an input job or output job is executed, the digital multi-function peripheral 101 generates attribute information of the job. The digital multi-function peripheral 101 transmits the attribute information to the information processing server 102.

In step S801, the information processing server 102 receives the attribute information from the digital multi-function peripheral 101. The information processing server 102 adds, to the received attribute information, expiration date information for storage indicating an expiration date in the database 103. In step S802, the information processing server 102 determines, based on job type information contained in the received attribute information, whether the job history to be stored in the database 103 is an output job. If the information processing server 102 determines that the job history is not an output job, it determines that the received job history is an input job, and the process shifts to step S805. If the information processing server 102 determines that the job history to be stored in the database 103 is an output job, the process shifts to step S803.

(Processing when Job History is Input Job)

In step S805, the information processing server 102 receives image data to be stored in the database 103 from the digital multi-function peripheral 101, and the process shifts to step S806. In step S806, the information processing server 102 stores, in the database 103, the attribute information and image data received as a job history from the digital multi-function peripheral 101 while associating expiration date information for storage in the attribute information with the image data. After this step, the information processing server 102 ends the job history storage processing. Note that the attribute information reception processing in step S801 and the image data reception processing in step S805 when the job history is an input job correspond to processing by the first reception unit.

(Processing when Job History is Output Job)

In step S803, the information processing server 102 determines whether image data having the same document ID as the document ID contained as reference information in the received attribute information exists in the database 103 as image data at the reference destination in the attribute information. This determination processing can adopt any method, for example, issuing an SQL statement to the database 103 or using a search result by the search server 104.

If the information processing server 102 determines in step S803 that image data at the reference destination does not exist in the database 103, the process shifts to step S805. In step S805, the information processing server 102 designates a document ID, requests the digital multi-function peripheral 101 to transmit image data, and then receives the requested image data. In step S806, the information processing server 102 stores, in the database 103, the attribute information and image data received as a job history from the digital multi-function peripheral 101 while associating expiration date information for storage in the attribute information with the image data.

If the information processing server 102 determines in step S803 that image data at the reference destination exists in the database 103, the process shifts to step S804. In step S804, the information processing server 102 changes the expiration date of the image data in the database 103 to the same expiration date as that of attribute information to be stored. In step S806, the information processing server 102 stores only the attribute information received from the digital multi-function peripheral 101 in the database 103. After this step, the information processing server 102 ends the job history storage processing. Note that the attribute information reception processing in step S801 and the image data reception processing in step S805 when the job history is an output job correspond to processing by the second reception unit.

As a predetermined expiration date, a common period may be set in the information processing system 100, or a different period may be set in accordance with job type information, a digital multi-function peripheral which executed a job, or attribute information such as a user who executed a job. When storing the job history of an output job in the database 103 by the information processing server 102, the expiration date of the job history to be stored may be changed to that of image data at the reference destination, instead of changing the expiration date of the image data. That is, it suffices to make the expiration date of image data at the reference destination coincide with that of attribute information referring to the image data. This can be achieved by any method. Also, the database 103 may change the expiration date of image data.

As described above, in the information processing system according to the embodiment of the present invention, when the image processing apparatus is to store the job history of an output job in the database via the information processing server, only attribute information including identification information of image data used to execute the job is stored. If the image data has already been stored in the database, the expiration date of the image data is changed to one added to the attribute information. The embodiment can therefore provide an information processing system and control method thereof for reducing a storage capacity requested of the database and preventing the expiration of reference to image data.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-066904, filed Mar. 18, 2009, which is hereby incorporated by reference herein in its entirety.

What is claimed is:

1. An information processing apparatus in an information processing system including an image processing apparatus which executes a job regarding image data, a storage apparatus which stores a history of the job executed by the image processing apparatus, and the information processing apparatus which receives the job history from the image processing apparatus and stores the job history in the storage apparatus, the information processing apparatus comprising:
a first reception unit that receives history information of an input job which was executed by the image processing apparatus and input image data, image data of the input job, and identification information for identifying the image data;
a second reception unit that receives history information of an output job which was executed by the image processing apparatus and output image data, and identification information for identifying image data of the output job;
a storage unit that stores, in the storage apparatus, the history information, image data, and identification information of the input job received by said first reception unit, and the history information and identification information of the output job received by said second reception unit;
an addition unit that adds, to at least the image data received by said first reception unit, expiration date information for storage indicating a period of storage in the storage apparatus; and
a change unit that, when said second reception unit receives history information of an output job and identification information for identifying image data of the output job, changes an expiration date indicated by the expiration date information for storage added by said addition unit to image data specified by the same identification information as the received identification information.

2. The apparatus according to claim 1, wherein said addition unit adds expiration date information for storage to history information received by said second reception unit, and said change unit changes expiration date information for storage for image data received by said first reception unit to coincide with the expiration date information for storage added to the history information received by said second reception unit.

3. The apparatus according to claim 1, wherein the history information stored in the storage apparatus by said storage unit includes information capable of specifying a job type, a date and time of job execution, and an image processing apparatus which executed a job.

4. The apparatus according to claim 1, wherein when the storage apparatus does not store image data corresponding to identification information received by said second reception unit, said second reception unit receives the image data corresponding to the identification information from the image processing apparatus.

5. A method of controlling an information processing apparatus in an information processing system including an image processing apparatus which executes a job regarding image data, a storage apparatus which stores a history of the job executed by the image processing apparatus, and the information processing apparatus which receives the job history from the image processing apparatus and stores the job history in the storage apparatus, the method comprising:
receiving history information of an input job which was executed by the image processing apparatus and input image data, image data of the input job, and identification information for identifying the image data;
receiving history information of an output job which was executed by the image processing apparatus and output image data, and identification information for identifying image data of the output job;
storing, in the storage apparatus, the history information, image data, and identification information of the input job received in the step of receiving history information of an input job, and the history information and identification information of the output job received in the step of receiving history information of an output job;
adding, to at least the image data received in the step of receiving history information of an input job, expiration date information for storage indicating a period of storage in the storage apparatus; and
when history information of an output job and identification information for identifying image data of the output job are received in the step of receiving history information of an output job, changing an expiration date indicated by the expiration date information for storage added in the step of adding expiration date information, to image data specified by the same identification information as the received identification information.

6. A computer-readable storage medium storing a computer program for causing a computer to execute steps in a method of controlling an information processing apparatus defined in claim 5.
